(19) United States
(12) Patent Application Publication
(10) Pub. No.: US 2015/0100802 A1
(43) Pub. Date: Apr. 9, 2015

(54) REDUCING POWER CONSUMPTION IN MULTI-DISPLAY ENVIRONMENTS

(71) Applicant: NVIDIA Corporation, Santa Clara, CA (US)

(72) Inventors: Jithin Thomas, Pune (IN); Darshan Uppinkere Bhadraiah, Pune (IN)

(73) Assignee: NVIDIA Corporation, Santa Clara, CA (US)

(21) Appl. No.: 14/047,725

(22) Filed: Oct. 7, 2013

(51) Int. Cl. G06F 1/32

(52) U.S. Cl. CPC G06F 1/3265
USPC 713/320

(57) ABSTRACT

The disclosure is directed to a system and method for selectively controlling display power consumption in a system with a first and second display. While the system is in a non-idle state and while an application that is actively executing has an active window on the first display, a determination is made that the second display is inactive. In response to the determination, and while the system is still in the non-idle state, the second display is switched from a full power state to a low power state.

### BACKGROUND

Increasingly, personal computers and other computing systems are being equipped with multiple displays. Multiple displays can significantly increase productivity and otherwise improve the user experience. The benefits, however, come with a cost—displays typically consume a significant amount of power.

One method for reducing power consumption is to dim display output when the system as a whole goes idle. This does reduce power consumption, however since it only operates when the system as a whole goes idle, it provides a limited benefit.

### BRIEF DESCRIPTION OF THE DRAWINGS

FIG. 1 schematically depicts a computing system with multiple displays, and that is operable, while the computing system is in a non-idle state, to selectively and individually switch the displays between full power and low power states based on whether the displays are active or inactive, as described in detail herein.

FIG. 2 depicts an example method for selectively controlling display power consumption in a multi-display environment.

FIG. 3 depicts an example two-display configuration in which one of the displays has entered an inactive state.

FIG. 4 depicts an operating system interface with an output that is usable to help determine whether to switch a display between a low power state and a full power state.

FIG. 5 depicts a pixel analysis method that is usable to help determine whether to switch a display between a low power state and a full power state.

FIGS. 6 and 7 depict examples of events that trigger a display to wake up from a low power state and resume operation in a full power state.

FIG. 8 depicts an example user interface for controlling the display power systems and methods described herein.

### DETAILED DESCRIPTION

This disclosure is directed to a computing system in which multiple different displays are used, and in which methods are used to selectively control power consumption by individually and selectively switching the power state of the displays. In one use scenario, there are two displays and the power state of one is switched to a low power state while the system is still in a non-idle condition. One of the displays in this scenario is being actively used—i.e., the computing system is actively executing a program that has an active window open on the actively used display. While the system is still in the non-idle state and while the first display is still being actively used, a determination is made that the other display is inactive. In response to this determination, the second display is switched out of its full power state and placed into a low power state, for example by reducing the output of a backlight associated with the display (e.g., dimming or turning off the backlight). The other display remains in a full power state and can continue to be used.

The determination of display inactivity may be made in various ways. One example context is a graphical user interface-based operating system using windows and a pointer-type cursor (e.g., a mouse-controlled pointer). Examples of such operating systems are Microsoft's® Windows® operating system and the Mac OS® series of operating systems from Apple, Inc. Inactivity for a display may be determined in such a context by determining—while the other display is still active (e.g., the user is watching a video)—that all three of the following are true: (1) that a pointer is not on the display; (2) that the display is free of non-minimized windows; and (3) that content on the display is unchanging. These conditions might occur, for example, when only the desktop of the user interface is visible on the display that is determined to be inactive. This is but one example of an inactivity determination; a variety of other methods may be employed. As an alternate example, the pointer check and/or the non-minimized windows requirement may be omitted. This alternate approach may be suitable, for example, in operating systems that employ touch-based inputs. Regardless, the determination and powering down of one of the displays is made while the system is still active, in contrast to existing methods which only reduce display power consumption when the system as a whole goes into an idle mode (e.g., CPU is idle), which in the case of a multiple display setup would trim power to all of the displays (i.e., non-selectively). The method herein therefore more effectively exploits opportunities to reduce power consumption while still maintaining a good user experience.

The inactive display may be returned to the full power state in response to a wakeup event. Examples include detecting when a pointer has been moved onto the inactive display, and/or detecting that content on the inactive display has changed.

The examples herein are all directed to a two-display configuration. It will be appreciated, however, that the concepts discussed herein are applicable to systems with three or more displays.

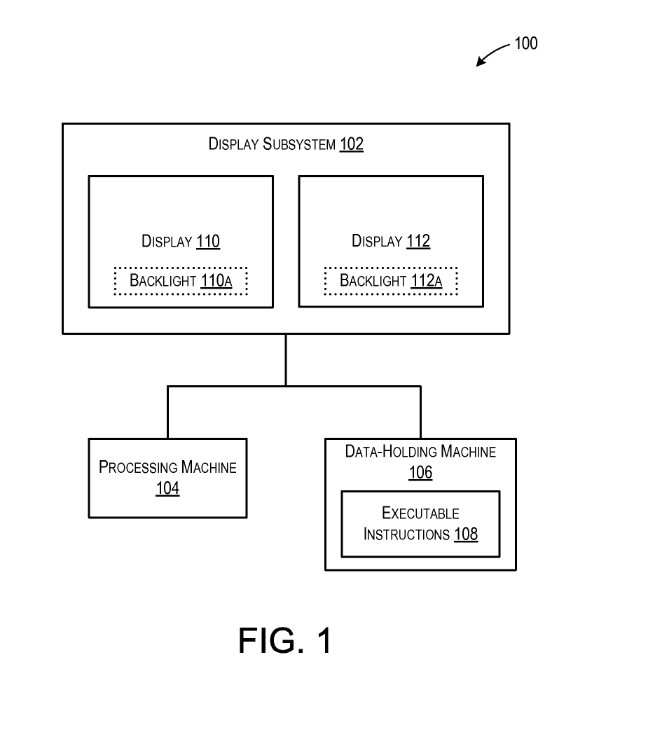

FIG. 1 depicts an exemplary computing system 100 including a display subsystem 102, processing machine 104 and data-holding machine 106 operatively coupled with one another. Computing system 100 is configured to enact one or more of the methods and processes described herein. In particular, data-holding machine 106 may hold executable instructions (e.g., instructions 108) configured to carry out various operations associated with selectively controlling display power states (e.g., power states of display 110 and 112) in response to inactivity and wakeup conditions. In some implementations, executable instructions 108 control display power states via manipulation of levels of backlights 110a and 112a of the displays. Specifically, selectively reducing and increasing backlight output can be used to switch displays between full power and low power states. “Full power state,” as used herein, refers to the power state that is employed and desirable for when the user is actively engaged, in an input/output sense, with content on the display (i.e., during normal active operation). Conversely, “low power state” refers to a state that is less than what a user would want if he were to be interacting with the display, and can include a partial or complete reduction of light emanating from the display. “Full power state” and “low power state” are relative terms, and do not necessarily imply maximum, minimum or other specific power levels.

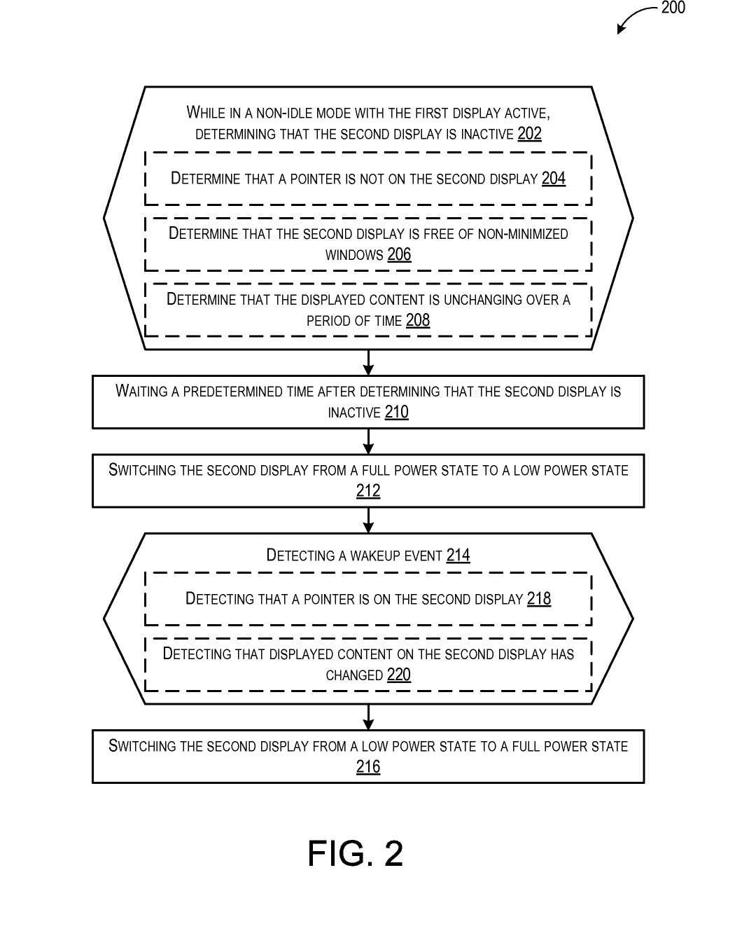

Referring now to FIG. 2, the figure shows an example method 200 for selectively controlling display power consumption in a computing system having two or more displays (e.g., displays 110 and 112). In some examples, the method is carried out via executable instructions, such as those depicted in FIG. 1. While FIG. 1 provides an example of a system capable of carrying out method 200, it will be understood that the method may be carried out with a wide variety of other system configurations.

Method 200 begins with the system in a state where the computing system is in a non-idle mode and is actively executing an application, with the application having an active window on one of the displays. At some point while this state exists, there is a determination that the other display is inactive, as shown at 202. In one implementation, inactivity is determined by determining that all of the following are true: (a) that a pointer is not on the second display, as shown at 204; (b) that the second display is free of non-minimized windows, as shown at 206; and (c) that content displayed on the second display screen is unchanging, as shown at 208. This is but an example, different conditions and/or combinations of conditions may be used to trigger an inactivity determination. In one alternate example, the pointer check and/or the non-minimized windows requirement may be omitted, for example in a touch-based environment with no mouse pointer.

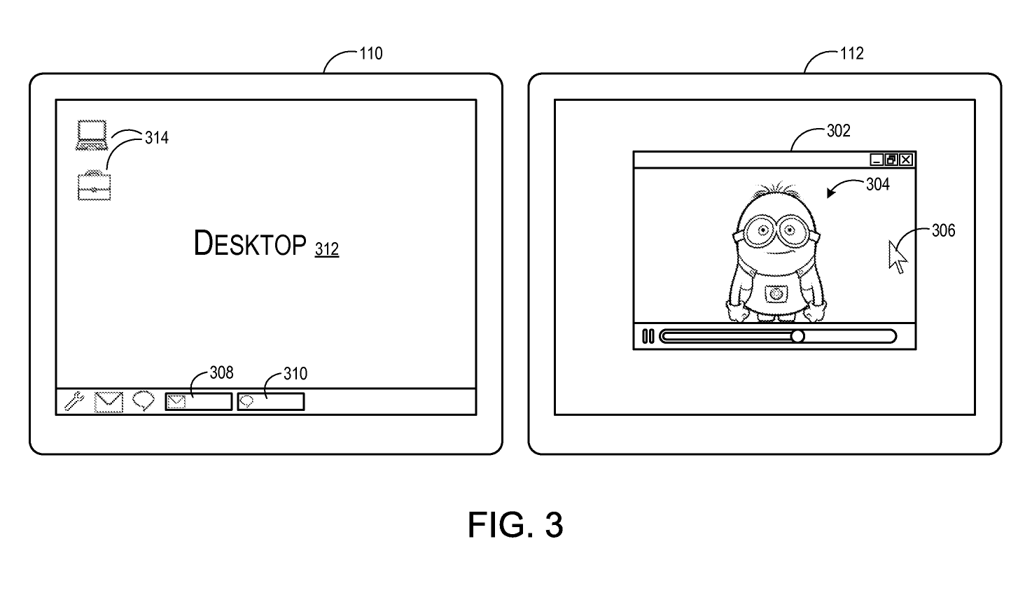

Referring now to FIG. 3, the figure shows displays 110 and 112 in the state just described. Display 112 is the active display: it has an active window 302 associated with an underlying application that is actively executing on the computing system—e.g., a video 304 being played within window 302. Meanwhile, display 110 is inactive. Specifically, no pointer is hovering over the display (pointer 306 is on display 112). Display 110 is free of non-minimized windows: windows 308 and 310, which are the only open windows on display 110, are both minimized. The content on the window is static (unchanging): windows are not opening, closing, or otherwise moving; windows are not actively outputting imagery or receiving user inputs; pixels on the screen are not changing; etc. In this example, the entire desktop surface 312 is exposed on the inactive display, except for occlusions by desktop icons 314.

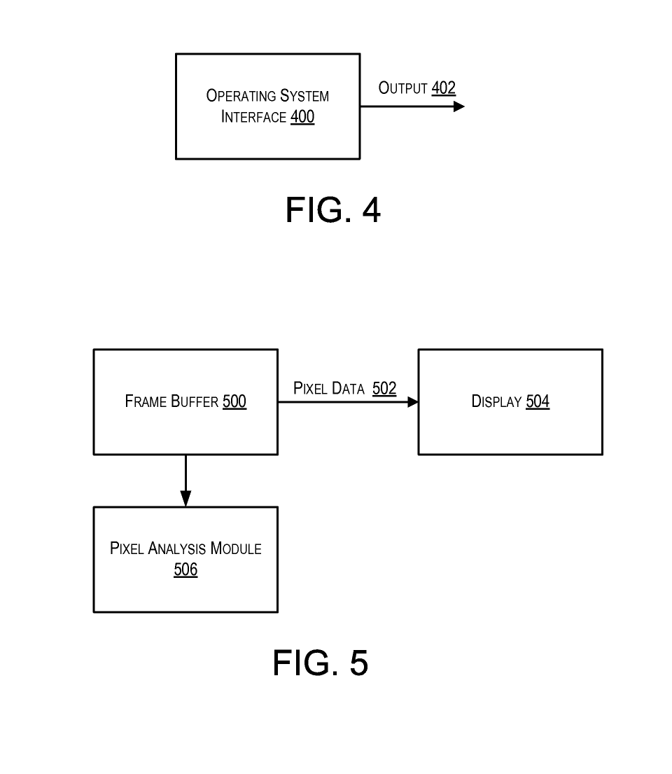

One or more operating system interfaces may be used to make a determination that a display is active or inactive. FIG. 4 schematically depicts an operating system interface 400—which may be implemented as part of executable instructions 108 as shown in FIG. 1—generating an output 402. Operating system interface 400 may be an API or any other type of interface that provides an output that can be assessed to determine the active/inactive state of a display. For example, output 402 can indicate information about windows on the display, such as whether a window is minimized, the size of a window, the number of windows open, whether a window is “in focus” (i.e., non-minimized and selected for use), etc. With positive indications of window activity, the system can infer, for example, that content on the display is changing, which corresponds to the display being active. The above should be understood as non-limiting examples. Any suitable operating system interface may be employed to make assessments about whether content is changing or to otherwise assess whether the display(s) is active or inactive. In general, the determination is made by analyzing the output 402 of the operating system interface 400. Another example of an operating system interface is an interface that reports the position of a pointer, such as pointer 306 in FIG. 3. For example, if the interface reports, as in FIG. 3, that the pointer is on display 112, that can form part of the inactivity determination, assuming the example where the absence of the pointer is one of the conditions of inactivity.

In some examples, determining that displayed content is not changing is part of the determination that a display is inactive. This may be determined by analyzing pixel data being sent to the display, an example of which is shown in FIG. 5. Specifically, the figure shows a frame buffer 500 sending pixel data 502 to display 504. A pixel analysis module 506 may be employed to analyze the pixel data being sent to the display (e.g., by analyzing the contents of frame buffer 500). Such an analysis can indicate, for example, that the pixel data being written to the display is unchanging. Typically, as described elsewhere, the system waits for a predetermined interval of unchanging pixel data before triggering the inactivity condition.

Returning now to FIG. 2, method 200 may include waiting for a period after inactivity is determined before varying the power state of the inactive monitor. This is shown at 210. In one example, the conditions shown at 204, 206 and 208 must all be true for an interval, which may be programmed/set by the end-user, before triggering a switch in the power state of the display.

In response to determining that the display is inactive, the display is switched to a low power state (212). This may include controlling a backlight of the display (e.g., one of the backlights shown in FIG. 1). The backlight may be dimmed by any amount, or may be turned off completely. Backlight control may be implemented via an API or other appropriate interface to the hardware. Instead of backlight control, switching to a low power state can be achieved by turning down, turning off, or otherwise manipulating the power supply of the display. These are but non-limiting examples; the disclosure contemplates any suitable method for changing operation of the display so that it consumes less power in the event of inactivity.

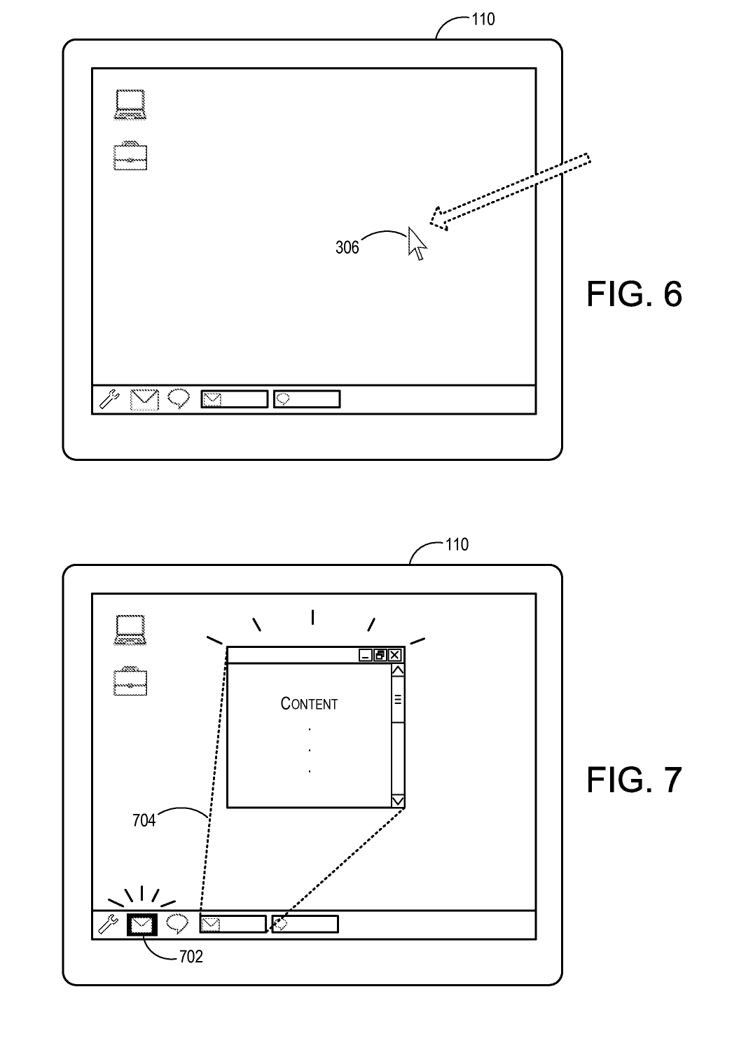

The method may further include returning the powered-down display to a full power state in response to detecting a wakeup event, as shown at 214 and 216. As shown at 218, one example of a wakeup event is detecting that a pointer has been brought onto the powered-down display. This is shown in FIG. 6, in which display 110 is triggered to return to the full power state in response to pointer 306 being moved from display 112 (not shown in FIG. 6) onto display 110. As indicated above, the location of the pointer may be determined via an output from an API or other operating system interface.

Detecting a wakeup event may also include detecting that content on the inactive display has changed, as shown at 220. FIG. 7 depicts examples of changing content on display 110. In the figure, desktop notification 702 causes the content to change in that the associated icon is blinking or has become brighter. This change in content can be detected by analyzing the output of an API or other operating system interface, by monitoring activity of other software such as an end-user application, by analyzing pixel data (e.g., as in FIG. 5), or through any other suitable method. Another example of changed content is expanding a minimized window to a non-minimized state, as shown at 704. And as discussed above, one way this window activity can be detected is via an operating system interface, though other methods can be employed.

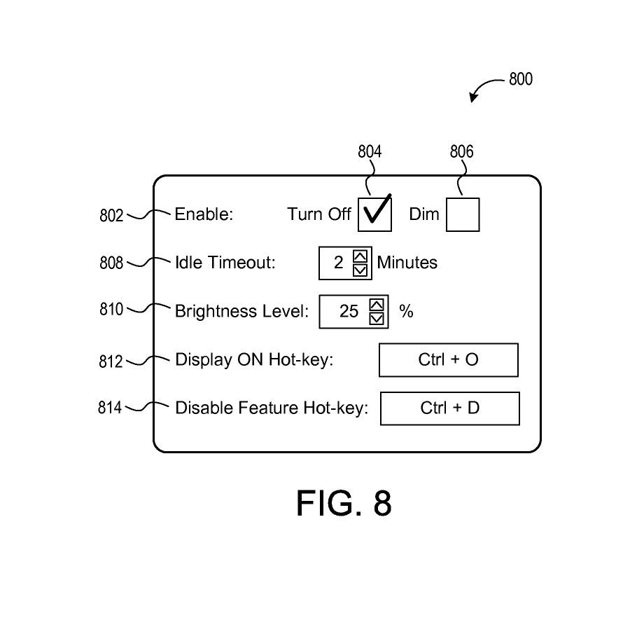

FIG. 8 depicts an example user interface 800 that may be used to provide end-user control over the power switching feature described herein. The user interface may be implemented as part of executable instructions 108 as shown in FIG. 1. At 802, the interface allows the user to disable the feature entirely, i.e., by leaving both the “turn off” and the “dim” boxes unchecked. If the “turn off” box is checked (804), as in the example, the feature is enabled so as to completely turn off the display (e.g., by fully dimming the backlight or through manipulation of the power supply). Alternatively, the user may optionally choose to dim the inactive display (box 806). At 808, the user may select the timeout period before the display is actually powered down (e.g., control over the time period specified in step 210 in FIG. 2). If the dim box 806 is checked, the user may elect the relative brightness level of the dimmed display, as shown at 810. At 812 of user interface 800, the user may choose a hot-key that acts to manually wake up a display that has been dimmed. At 814, the interface allows the user to specify a hot-key which will toggle the feature on and off (i.e., without having to make explicit use of the interface). It should be understood that the depicted interface is exemplary in nature, and a wide variety of other methods may be used to provide the user with the ability to enable and disable the feature, and control the particulars of how it operates.

The methods and processes described herein may be tied to a computing system of one or more computing devices, such as computing system 100 (FIG. 1). In particular, such methods and processes may be implemented as a computer-application program or service, an application-programming interface (API), a library, and/or other computer-program product. Computing system 100 is shown in simplified form and can enact one or more of the methods and processes described above. Computing system 100 may take the form of one or more personal computers, server computers, tablet computers, home-entertainment computers, network computing devices, or any other type of computing device capable of working with multiple displays, such as displays 110 and 112.

As discussed above, computing system 100 includes a processing machine 104, a data-holding machine 106 and a display subsystem 102 having multiple displays. Computing system 100 may optionally include an input subsystem, communication subsystem, and/or other components not shown in FIG. 1.

Processing machine 104 includes one or more physical devices configured to execute instructions, such as executable instructions 108 for implementing the described power state control for multiple displays. The instructions may be part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The processing machine may include one or more processors configured to execute software instructions (e.g., instructions 108). Additionally or alternatively, the processing machine may include one or more hardware or firmware processing machines configured to execute hardware or firmware instructions. Processors of the processing machine may be single-core or multi-core, and the instructions executed thereon may be configured for sequential, parallel, and/or distributed processing. Individual components of the processing machine optionally may be distributed among two or more separate devices, which may be remotely located and/or configured for coordinated processing. Aspects of the processing machine may be virtualized and executed by remotely accessible, networked computing devices configured in a cloud-computing configuration.

Data-holding machine 106 includes one or more physical devices configured to hold instructions executable by the processing machine to implement the methods and processes described herein. When such methods and processes are implemented, the state of data-holding machine 106 may be transformed—e.g., to hold different data.

Data-holding machine 106 may include removable and/or built-in devices. Data-holding machine 106 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Data-holding machine 106 may include volatile, nonvolatile, dynamic, static, read/write, read-only, random-access, sequential-access, location-addressable, file-addressable, and/or content-addressable devices.

It will be appreciated that data-holding machine 106 includes one or more physical devices. However, aspects of the instructions described herein alternatively may be propagated by a communication medium (e.g., an electromagnetic signal, an optical signal, etc.) that is not held by a physical device for a finite duration.

Aspects of processing machine 104 and data-holding machine 106 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

Display subsystem 102 may be used to present a visual representation of data held by data-holding machine 106. This visual representation may take the form of a graphical user interface (GUI), such as that described with reference to FIG. 8. As the herein described methods and processes change the data held by the data-holding machine, and thus transform the state of the data-holding machine, the state of display subsystem 102 may likewise be transformed to visually represent changes in the underlying data. Display devices 110 and 112 may use virtually any type of technology. One or more of the display devices may be combined with processing machine 104 and/or data-holding machine 106 in a shared enclosure, or such display devices may be peripheral display devices.

When included, an input subsystem may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, a communication subsystem may be configured to communicatively couple computing system 100 with one or more other computing devices. The communication subsystem may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 100 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof

1. In a computing system with a first display and a second display, a method for selectively controlling display power consumption, comprising:
while the computing system is in a non-idle state and while an application that is actively executing on the computing system has an active window on the first display, determining that the second display is inactive; and
in response to and after the determination that the second display is inactive, and while the computing system is in the non-idle state, switching the second display from a full power state to a low power state.

2. The method of claim 1, further comprising:
detecting a wakeup event associated with the second display; and
in response to detecting the wakeup event, switching the second display back to the full power state.

3. The method of claim 2, where detecting the wakeup event includes one or more of detecting that a pointer is on the second display and detecting that content displayed on the second display has changed.

4. The method of claim 2, where detecting the wakeup event includes one or more of (a) analyzing output of an operating system interface of the computing system, and (b) analyzing pixel data sent to the second display.

5. The method of claim 1, where determining that the second display is inactive includes determining that content displayed on the second display is unchanging.

6. The method of claim 1, where determining that the second display is inactive occurs upon determining that all of the following conditions are true: (a) that a pointer is not on the second display; (b) that the second display is free of non-minimized windows; and (c) that content displayed on the second display is unchanging.

7. The method of claim 6, where determining the truth of the conditions includes one or more of (a) analyzing output of an operating system interface of the computing system, and (b) analyzing pixel data sent to the second display.

8. The method of claim 1, where switching the second display to the low power state includes reducing output of a backlight of the second display.

9. The method of claim 1, where the method further comprises waiting for a predetermined time after determining that the second display is inactive before switching the second display to the low power state.

10. The method of claim 1, where determining whether or not the second display is inactive is made via analyzing output of an operating system interface of the computing system.

11. A computing system operable to selectively control display power consumption, comprising:
a first display;
a second display; and
a processing machine operatively coupled with a data-holding machine, the data-holding machine containing executable instructions configured to:
while the computing system is in a non-idle state and while an application that is actively executing on the computing system has an active window on the first display, determine that the second display is inactive; and
in response to and after the determination that the second display is inactive, and while the computing system is in the non-idle state, switch the second display from a full power state to a low power state.

12. The computing system of claim 11, where the executable instructions are configured to determine that the second display is inactive when all of the following conditions are true: (a) that a pointer is not on the second display; (b) that the second display is free of non-minimized windows; and (c) that content displayed on the second display screen is unchanging.

13. The computing system of claim 12, where determining the truth of the conditions includes the executable instructions performing one or more of (a) analyzing output of an operating system interface of the computing system, and (b) analyzing pixel data sent to the second display.

14. The computing system of claim 11, where the executable instructions are further configured to:
detect a wakeup event associated with the second display; and
in response to detecting the wakeup event, switch the second display back to the full power state.

15. The computing system of claim 14, where detecting the wakeup event includes the executable instructions performing one or more of (a) analyzing output of an operating system interface of the computing system, and (b) analyzing pixel data sent to the second display.

16. The computing system of claim 11, where the executable instructions are configured to switch the second display to the low power state via reducing output of a backlight of the second display.

17. In a computing system with a first display and a second display, a method for selectively controlling display power consumption, comprising:
while the computing system is in a non-idle state and while an application that is actively executing on the computing system has an active window on the first display, determining that the second display is inactive by determining that all of the following conditions are true: (a) that a pointer is not on the second display; (b) that the second display is free of non-minimized windows; and (c) that content displayed on the second display screen is unchanging; and
in response to and after the determination that the second display is inactive, and while the computing system is in the non-idle state, switching the second display from a full power state to a low power state.

18. The method of claim 17, further comprising:
detecting a wakeup event associated with the second display; and
in response to detecting the wakeup event, switching the second display back to the full power state.

19. The method of claim 17, where switching the second display to the low power state includes reducing output of a backlight of the second display.

20. The method of claim 17, where determining the truth of the conditions includes one or more of (a) analyzing output of an operating system interface of the computing system, and (b) analyzing pixel data sent to the second display.
